(19) United States
(12) Patent Application Publication
(10) Pub. No.: US 2026/0023009 A1
(43) Pub. Date: Jan. 22, 2026

(54) Test Chamber and Control Method

(71) Applicant: Weiss Technik GmbH, Reiskirchen (DE)

(72) Inventors: Yannik Zahrt, Rabenau (DE); Christian Haack, Marburg (DE); Felix Maul, Reiskirchen (DE)

(21) Appl. No.: 19/270,975

(22) Filed: Jul. 16, 2025

(30) Foreign Application Priority Data
Jul. 18, 2024 (EP) 24189415.3

(51) Int. Cl. G01N 17/00; F24F 11/72; F24F 11/84; F24F 11/86

(52) U.S. Cl. CPC G01N 17/002; F24F 11/72; F24F 11/84; F24F 11/86

(57) ABSTRACT

In a test chamber, a temperature from −20° C. to +180° C. is established within a test space by a cooling device of a temperature control device, which comprises a cooling circuit with CO₂ as a refrigerant, a heat exchanger in the test space, a compressor, an oil device, a gas cooler, and an expansion valve. The temperature is controlled and/or regulated by a control device, oil is separated from the refrigerant by at least one oil separator and is conducted to the compressor by a feeding device, a pressure P of the refrigerant being produced during a standstill of the compressor and at a refrigerant temperature of at least 20° C. A partial quantity of the CO₂ is absorbed by the oil, a quantity of CO₂ and/or oil in the cooling circuit for producing pressure P is selected taking into account the absorption of the partial quantity of the CO₂.

### CROSS-REFERENCE TO RELATED APPLICATIONS

This patent application claims priority to European Patent Application No. 24189415.3 filed Jul. 18, 2024, the contents of which are incorporated herein by reference in its entirety for all purposes.

### TECHNICAL FIELD

This disclosure relates to a test chamber, in particular a climate chamber, for conditioning air and to a method for conditioning air in a test space of a test chamber, in particular a climate chamber, for receiving test material, the test space being sealable against an environment and being temperature-insulated, a temperature in a temperature range of −20° C. to +180° C. being established within the test space by a cooling device of a temperature control device of the test chamber, which comprises a cooling circuit with carbon dioxide as a refrigerant, a heat exchanger in the test space, a compressor, an oil device, a gas cooler, and an expansion valve, the temperature in the test space being controlled and/or regulated by a control device of the test chamber, oil being separated from the refrigerant by at least one oil separator of the oil device and being conducted to the compressor by a feeding device of the oil device, a pressure P of the refrigerant being produced in the cooling circuit during a standstill of the compressor and at a temperature of the refrigerant corresponding to an ambient temperature, in particular of at least 20° C.

### BACKGROUND

Test chambers of this kind are regularly used to test physical and/or chemical properties of objects, in particular devices. For example, there are known temperature test cabinets or climatic test cabinets within which temperatures in a range from −70° C. to +180° C. can be set. In the case of climatic test cabinets, desired climatic conditions can be additionally set, to which the device or the test material is then exposed over a defined period of time. The temperature of a test space containing the test material to be tested is regularly controlled in an air circulation duct within the test space. The air circulation duct forms an air treatment space in the test space, in which heat exchangers for heating or cooling the air flowing through the air circulation duct or the test space are disposed. A fan or a ventilator aspirates the air in the test space and guides it through the air circulation duct to the respective heat exchangers. The test material can thus be temperature-controlled or also exposed to a defined change in temperature. In this case, during a test interval, a temperature can change, for example, between a temperature maximum and a temperature minimum of the test chamber. A test chamber of this kind is known from EP 0 344 397 A2, for example.

The refrigerant used in a cooling circuit should have a relatively low CO₂ equivalent, i.e., a relative greenhouse potential or global warming potential (GWP) should be as low as possible in order to avoid indirect damage to the environment by the refrigerant upon release. It is therefore also known for carbon dioxide (CO₂) to be used as a pure-substance refrigerant. Carbon dioxide is available at low cost, is non-flammable and is essentially environmentally neutral with a GWP of 1. Carbon dioxide has a freezing temperature or a triple point of −56.6° C., which makes it impossible to achieve lower temperatures with carbon dioxide alone.

Since carbon dioxide as a refrigerant has a very high volumetric cooling capacity, a very high cooling capacity is provided by the cooling circuit even when using compressors with a very low stroke volume flow. In addition, a pressure range of cooling circuits with carbon dioxide as the refrigerant is very high (up to 120 bar) in transcritical operation, which is why the components required to form the cooling circuit are comparatively expensive.

Furthermore, cooling devices are known which are configured as what is referred to as booster systems. In a cooling circuit of said cooling devices, a high-pressure compressor is always connected in series downstream of a low-pressure compressor, so that the refrigerant is compressed in stages with the low-pressure compressor and then with the high-pressure compressor. Due to the high demands on temperature control within the temperature range of the test space, a load requirement frequently fluctuates during operation of the test chamber. Hence, a cooling capacity generated by the compressors and the expansion valve has to be infinitely variable. At the same time, it is desirable for the compressors to not be switched on and off frequently in order to extend a service life of the compressors.

During an operation of the cooling device, oil is fed from an oil device to the cooling circuit. In this process, the oil is metered into a compressor housing of the compressor, thus lubricating the moving components of the compressor. The oil mixes with the refrigerant and reaches an oil separator in the cooling circuit downstream of the compressor in the flow direction of the refrigerant, the oil in the refrigerant being separated via said oil separator and fed back to the compressor in the manner of a circuit. Oil has to be continuously fed to the compressor whenever the compressor is operated in order to ensure a sufficient lubrication of the compressor.

Load fluctuations occur as a function of a temperature change in the test space such that the compressor is also put out of operation. A standstill of the compressor sets in whenever a cooling of the test space is required or, for example, very high temperatures of up to +180° C. are to be established. In this case, comparatively cold refrigerant under high pressure can still be in the cooling circuit, for example in a storage device. Thus, a quick cooling of the heat exchanger in the test space can also be made possible again if this should be required. If the compressor is brought to a standstill over a longer period of time, for example, if the test chamber is put out of operation, is to be transported or has not yet been put into operation, the refrigerant in the cooling circuit inevitably takes on an ambient temperature. Depending on an ambient temperature, which can be, for example, 20° C., 35° C. or also up to 55° C. during transport, a standstill pressure of the refrigerant sets in within the cooling circuit. In this case, the danger exists that a maximally allowable pressure of the refrigerant is exceeded within the cooling circuit. Therefore, it is known to provide cooling circuits with a so-called standstill cooling in order to cool down at least a part of the refrigerant to such an extent that the maximally allowable pressure is not exceeded. Furthermore, one or more safety valves can also be provided on the cooling circuit, wherein refrigerant can escape from the cooling circuit into an environment via said safety valve(s) if the maximally allowable pressure is exceeded. These safety valves have to be replaced after triggering. In this case, it is disadvantageous that the standstill cooling is not active during transport, possibly has to be powered and is comparatively cost-intensive. For putting the test chamber into operation, the refrigerant which has escaped via a safety valve has to be refilled into the cooling circuit again in order to provide the required quantity of refrigerant in the cooling circuit. For this purpose, a corresponding maintenance of the test chamber is then required.

### SUMMARY

Hence, the object of the present disclosure is to propose a method for conditioning air in a test space of a test chamber and a test chamber which enable an inexpensive operation and transport.

This object is attained by a method having the features of described herein and a test chamber having the features described herein.

In the method according to the disclosure for conditioning air in a test space of a test chamber, in particular a climate chamber, for receiving test material, the test space being sealable against an environment and being temperature-insulated, a temperature in a temperature range of −20° C. to +180° C. is established within the test space by a cooling device of a temperature control device of the test chamber, which comprises a cooling circuit with carbon dioxide as a refrigerant, a heat exchanger in the test space, a compressor, an oil device, a gas cooler, and an expansion valve, the temperature in the test space being controlled and/or regulated by a control device of the test chamber, oil being separated from the refrigerant by at least one oil separator of the oil device and being conducted to the compressor by a feeding device of the oil device, a pressure P of the refrigerant being produced in the cooling circuit during a standstill of the compressor and at a temperature of the refrigerant corresponding to an ambient temperature, in particular of at least 20° C., wherein a partial quantity of the carbon dioxide is absorbed by the oil, a quantity of carbon dioxide and/or a quantity of oil in the cooling circuit for producing pressure P being selected taking into account the absorption of the partial quantity of the carbon dioxide.

The compressor may be switched off during the operation of the test chamber if a temperature in the test space is to be increased in the course of a test cycle starting from a comparatively low temperature in the test space of −20° C., for example. In this case, often, cold refrigerant which is still compressed is within the cooling circuit and a pressure difference is produced between a high-pressure side from the compressor to the expansion valve in a flow direction of the refrigerant and a low-pressure side of the cooling circuit from the expansion valve to the compressor in a flow direction of the refrigerant. If the compressor is switched off and/or the test chamber is put out of operation over a longer period of time, a pressure equalization between the high-pressure side and the low-pressure side of the cooling circuit sets in via the expansion valve or a bypass of the cooling circuit, which runs between the high-pressure side and the low-pressure side. Furthermore, the refrigerant takes on an ambient temperature. As a reference, in this case, an ambient temperature of 20° C. can be assumed. In the case of a pressure equalization between the high-pressure side and the low-pressure side, essentially the same pressure P of the refrigerant is produced within the cooling circuit.

Surprisingly, it has been found that the oil, which is in the cooling circuit together with the refrigerant, can absorb a part or a partial quantity of the refrigerant and/or the carbon dioxide. This means that molecules of the carbon dioxide are incorporated within molecules of the oil. The absorption is carried out to a usable extent, in particular at higher temperatures and/or at a temperature of at least 20° C. or more, such that this effect for delimiting a standstill pressure of the refrigerant can be utilized. A volume of the cooling circuit, which has the quantity of carbon dioxide therein and the quantity of oil, and a temperature of these substances are important variables for producing pressure P.

In particular a higher temperature causes a phase change of the carbon dioxide and further a pressure increase due to thermal expansion. Since a partial quantity of carbon dioxide is absorbed by the oil, a volume of the carbon dioxide is reduced, which results in a pressure reduction. According to the disclosure, now, the quantity or a total quantity of carbon dioxide and/or a quantity or a total quantity of oil in the cooling circuit for producing the standstill pressure or pressure P to be achieved may be selected taking into account the absorption of the partial quantity of the carbon dioxide in the oil. This means that the quantity of carbon dioxide and the quantity of oil are adjusted to each other to such an extent that pressure P of the refrigerant in the cooling circuit is not exceeded at 20° C. Alternatively, the adjustment can be carried out in such a manner that pressure P of the refrigerant in the cooling circuit is not exceeded at 35° C., preferably at 55° C. Consequently, in this case, also, no constructive measures, which prevent that an inadmissibly high pressure sets in during a standstill of the compressor, need to be taken. This can substantially simplify a design and thus the production of the cooling device. In addition, the test chamber can be transported more easily and no testing and maintenance are needed before a start-up with the otherwise required refilling of refrigerant into the cooling circuit.

Thus, the partial quantity of the carbon dioxide may be absorbed by the oil during a standstill of the compressor and at a temperature of the refrigerant of at least 20° C. For example, depending on the used oil and pressure in the cooling circuit, the partial quantity of the carbon dioxide can be between 2% and 35% of the total quantity of carbon dioxide. In particular, it is also advantageous if a pressure P from 20 bar to 120 bar, preferably from 40 bar to 50 bar, is produced at 20° C. in the cooling circuit during the standstill of the compressor.

A ratio of the quantity of carbon dioxide and the quantity of oil in the cooling circuit may be selected taking into account the absorption of the partial quantity of the carbon dioxide. In this case, the ratio or a quotient of the quantity of carbon dioxide and the quantity of oil can be determined for the respective volume of the cooling circuit and pressure P at 20° C. The ratio and/or the respective quantities of oil and carbon dioxide can also be selected for any other temperature of the refrigerant. In this case, the respective absorptance of the carbon dioxide in the oil can then be taken into account.

The quantity of oil in the cooling circuit may be selected to be larger than a quantity of oil required for the operation of the compressor. In order to guarantee an operation of the compressor with a long idle time, the oil device always has to have a required quantity of oil which is large enough to guarantee a continuous lubrication of the compressor in operation. As a rule, using a larger quantity of oil in the cooling circuit does not make sense since this results in higher costs, reduces a total quantity of carbon dioxide and, possibly, also requires an oil separator suitable for larger oil volumes. As was found, the increase of the total quantity of oil in the cooling circuit however leads to the fact that a larger quantity of carbon dioxide can be absorbed by the oil, which, in turn, can be used advantageously in order to achieve pressure P during a standstill of the compressor. Thus, other possibly required constructive measures for delimiting the pressure or for reinforcing the design of the cooling circuit can now be dispensed with, which enables a more inexpensive operation of the test chamber overall.

In the cooling circuit, pressure P of the refrigerant may be smaller than or of the same size as a pressure Pₘₐₓ of the refrigerant, which is maximally allowable for the cooling circuit. The maximally allowable pressure is understood to be a pressure within the meaning of the directives and technical regulations applicable to generic cooling circuits at the priority date, preferably in accordance with the Pressure Equipment Directive 2014/68/EU and/or DIN EN 378. If the quantity of carbon dioxide and oil is selected in such a manner that the maximally allowable pressure is not exceeded due to the absorption of the carbon dioxide in the oil, the otherwise usual constructive safety measures can be dispensed with.

Thus, the refrigerant may neither be cooled by a standstill cooling nor drained from the cooling circuit by a safety valve during the standstill of the compressor and at the temperature of the refrigerant of at least 20° C. In this case, the standstill cooling and/or the safety valve can be dispensed with. In this case, the problem of having to carry out maintenance after transporting the test chamber in order to determine if refrigerant has escaped into an environment via the safety valve can also no longer occur. In principle, a safety valve can still be present, however, pressure P of the refrigerant can, in this case, be set in such a manner that it is significantly smaller than maximally allowable pressure Pₘₐₓ of the safety valve.

Oil may be stored by a collector of the oil device, wherein the oil in the collector may be conducted to the compressor via at least one feeding valve in a feeding line of the feeding device. The feeding valve can be controlled and/or regulated by the control device, for example. The collector can receive a partial quantity and/or a predominant quantity of the oil in the cooling circuit. In this case, the oil in the collector can be exposed to the same pressure as the refrigerant in the cooling circuit. In this case, the carbon dioxide in the oil in the collector can be absorbed without further constructive measures. The collector can be constituted in such a manner that at least a total quantity of the oil in the cooling circuit can be stored in the collector. In this case, the oil in the collector can simply be dispensed into the feeding line via the feeding valve, wherein the oil can then reach the compressor via the feeding line.

The feeding valve may opened when the compressor is operated and the feeding valve may be closed when the compressor is stopped. In this case, during a standstill of the compressor, the oil is not further conducted to the compressor such that a quantity of oil, which is as large as possible, is available for absorbing the carbon dioxide. Depending on the design of the compressor, the quantity of oil in the compressor can also be used to absorb the carbon dioxide.

Oil may be metered into the compressor in the feeding line to the compressor by a metering valve of the feeding device. The metering valve can be installed directly at or adjacent to the compressor in the feeding line. For example, the metering valve can delimit a cross section of the feeding line to such an extent that only the quantity of oil required for the compressor reaches said compressor. Thus, an unnecessarily high volume flow of oil in the feeding line and a line section from the compressor in the flow direction of the refrigerant to the oil separator can be limited.

A partial quantity of the oil in the collector may be increased with a rising temperature of the refrigerant and reduced with a falling temperature of the refrigerant by the oil device. Consequently, the partial quantity of the oil in the collector can be varied in such a manner that they are advantageously adjusted to an absorptance of the oil, which depends on the temperature of the refrigerant during an operation or a standstill of the compressor and/or to an ambient temperature. In principle, the total quantity of the oil in the cooling circuit may also be used for absorbing carbon dioxide. At a very low temperature of the refrigerant of, for example, 20° C., an absorption of carbon dioxide in the oil can be ignored and is thus hardly usable for the production of a desired pressure P. Therefore, more oil can be used within the cooling circuit for the lubrication of the compressor. At a high pressure in the cooling circuit, a strong dilution of the oil and, thus, a decrease of a viscosity of the oil can occur. In this respect, it is advantageous if sufficient lubrication of the compressor is always provided during an operation of the compressor.

Furthermore, a partial quantity of the oil in the collector may be adjusted essentially linearly in relation to a temperature of the refrigerant by the oil device. This linear adjustment can be carried out via the feeding valve and be controlled and/or regulated by the control device. Since an absorptance of carbon dioxide in the oil also behaves essentially linearly as a function of a temperature and a pressure, the partial quantity of oil in the collector can be advantageously adjusted to this ratio.

A filling volume of the collector may be at least as large as a volume of oil in the cooling circuit. In this case, the collector can receive all the oil which is in the cooling circuit. In this case, it is also not required to provide a possibly external storage container for oil, which is coupled to the collector. In principle, it is, however, also possible to regulate an oil volume via a storage container of this kind. The filling volume of the collector can be dimensioned in such a manner that the collector can receive the total quantity of oil at a temperature of the refrigerant of 35° C. During transport of the test chamber, an ambient temperature can reach this value or up to 55° C.

Polyol ester oil may be used as oil. The oil can additionally be provided with additives which can improve a wear protection of the compressor. Furthermore, polyol ester oil can mix well with carbon dioxide, is thermally very stable and has a very low evaporation temperature and very good lubricating properties.

The cooling circuit may be realized with a low-pressure compressor and a high-pressure compressor downstream of the low-pressure compressor in a flow direction of the refrigerant. In this case, the oil separator can be disposed in the cooling circuit downstream of the high-pressure compressor and upstream of the gas cooler in the flow direction of the refrigerant. In this case, the refrigerant can flow from the low-pressure compressor to the high-pressure compressor. The refrigerant may either be fed to the low-pressure compressor and then to the high-pressure compressor or to the high-pressure compressor alone by the valve device. Depending on the load requirement, the low-pressure compressor together with the high-pressure compressor or just the high-pressure compressor alone can then be operated. Therefore, during ongoing operation of the test chamber, the low-pressure compressor can be switched off temporarily, thereby saving a large part of the energy otherwise required for the operation of the compressors. By connecting the low-pressure compressor and the high-pressure compressor in series, the refrigerant can be compressed in stages.

Advantageously, pure carbon dioxide may be used as the refrigerant. Pure carbon dioxide has a GWP of 1, is non-flammable, non-hazardous and available at low cost. In addition, carbon dioxide is a pure substance or azeotropic, which is what makes the advantageous implementation of the method and its variations possible in the first place.

The cooling circuit may be operated in a thermodynamically transcritical state or in a subcritical state. Depending on the cooling load requirement within the test space, the operating state can be changed accordingly using the control device. In subcritical operation of the cooling circuit, the refrigerant is liquefied in the gas cooler below the critical point of the refrigerant and expanded at the expansion valve and converted to the gaseous phase or wet steam. The compressor and, if present, the high-pressure compressor and the low-pressure compressor can be operated at least in the subcritical operating state. The subcritical operating state of the cooling circuit corresponds to partial load operation. In the transcritical operating state, the refrigerant circulates in the cooling circuit essentially in a gaseous state. This means that a difference in temperature is reduced to such an extent that the refrigerant is not liquefied in the gas cooler. Also, a pressure above the critical point of the refrigerant is reached at the gas cooler in the transcritical operating state. If there is a high cooling load requirement or cooling from +180° C. to −20° C. is required, for example, the cooling circuit can be operated transcritically. If there is a low cooling load requirement within the test space, for example if a temperature is to be kept constant, or if there are low ambient temperatures, the cooling circuit can be operated subcritically. This allows an increase in efficiency to be achieved in particular in the case of low cooling load requirements in contrast to exclusively transcritical operating states.

A temperature in a temperature range of −40° C. to +180° C., preferably −55° C. to +180° C., can be established within the test space by the temperature control device.

The test chamber according to the disclosure, in particular climate chamber, for conditioning air, comprises a test space for receiving test material, the test space being sealable against an environment and being temperature-insulated, and a temperature control device for controlling the temperature of the test space, a temperature in a temperature range of −20° C. to +180° C. being establishable within the test space by the temperature control device, the temperature control device having a cooling device comprising a cooling circuit with carbon dioxide as a refrigerant, a heat exchanger in the test space, a compressor, an oil device, a gas cooler, and an expansion valve, the test chamber having a control device for controlling and/or regulating the temperature in the test space, oil being separable from the refrigerant by at least one oil separator of the oil device and being capable of being conducted to the compressor by a feeding device of the oil device, a pressure P of the refrigerant being producible in the cooling circuit during a standstill of the compressor and at a temperature of the refrigerant corresponding to an ambient temperature, in particular of at least 20° C., wherein a partial quantity of the carbon dioxide is absorbable by the oil, a quantity of carbon dioxide and/or a quantity of oil in the cooling circuit for producing pressure P being selected taking into account the absorption of the partial quantity of the carbon dioxide. Regarding the advantages of the test chamber according to the disclosure, reference is made to the description of advantages of the method according to the disclosure.

The oil device may have a collector for storing oil, wherein the collector can be formed separately from or integrally with the oil separator. If the collector and the oil separator are formed separately, the collector can be connected via a line, in which the oil is conducted from the oil separator to the collector. If the collector and the oil separator are formed integrally, the collector is formed directly on the oil separator, for example within a common housing.

The temperature control device may comprise a heating device having a heater and a heating heat exchanger in the test space. For example, the heating device can be an electrical resistance heater that heats the heating heat exchanger in such a manner that an increase in temperature in the test space is made possible via the heating heat exchanger. If the heat exchanger and the heating heat exchanger can be controlled and/or regulated in a targeted manner by the control device to cool or heat the air circulated in the test space, a temperature in the temperature range specified above can then be established within the test space by the temperature control device.

Other embodiments of a test chamber are apparent from the descriptions of features of the dependent claims.

### BRIEF DESCRIPTION OF THE FIGURES

Hereinafter, a preferred embodiment is explained in more detail with reference to the accompanying drawings.

In the figures:

FIG. 1 shows an embodiment of a cooling device;

FIG. 2 shows a diagram of the incorporation of carbon dioxide into a refrigerant oil.

### DETAILED DESCRIPTION

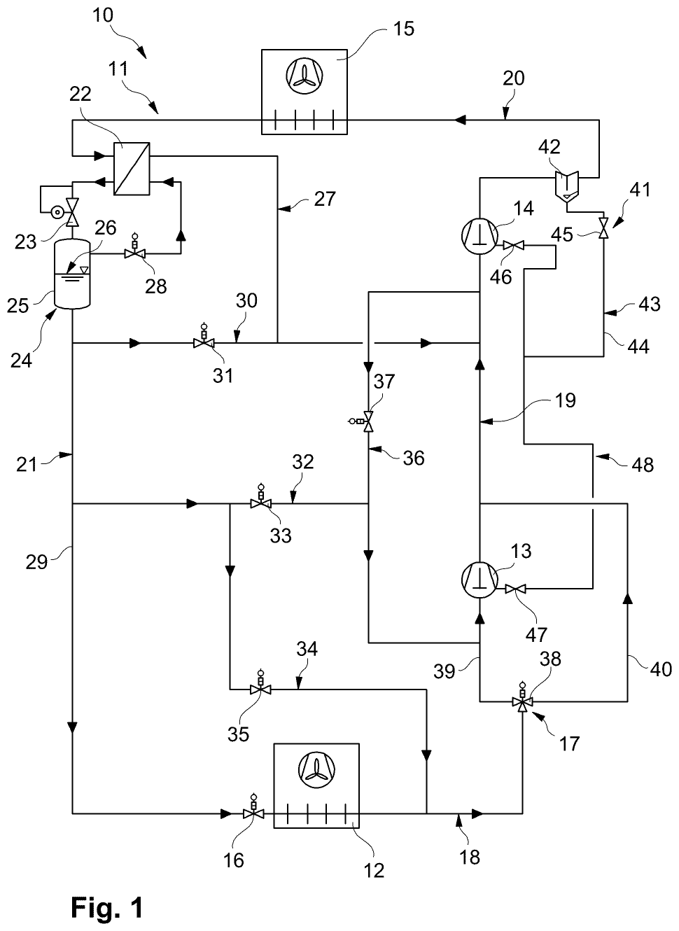

FIG. 1 shows a possible embodiment of a cooling device 10 of a test chamber (not illustrated in the case at hand). Cooling device 10 comprises a cooling circuit 11 with carbon dioxide (CO₂) as a refrigerant, a heat exchanger 12, a low-pressure compressor 13, a high-pressure compressor 14, a gas cooler 15, an expansion valve 16, and a valve device 17. In the case at hand, gas cooler 15 is configured in the manner of a heat exchanger and is cooled by a heat transfer medium, such as air or water. Heat exchanger 12 is disposed in an air treatment duct (not illustrated in the case at hand) of the test chamber in such a manner that a fan (not illustrated in the case at hand) can circulate the air in the test space at heat exchanger 12. Furthermore, cooling circuit 11 has a low-pressure side 18, an intermediate-pressure side 19, a high-pressure side 20 and a medium-pressure side 21. In low-pressure side 18, a pressure of the refrigerant is comparatively lower than in intermediate-pressure side 19. In intermediate-pressure side 19, a pressure of the refrigerant is comparatively lower than in medium-pressure side 21 and, in medium-pressure side 21, a pressure of the refrigerant is comparatively lower than in high-pressure side 20.

Downstream of gas cooler 15 in a flow direction of the refrigerant, cooling circuit 11 further has an internal heat exchanger 22 and a high-pressure valve 23 via which gaseous refrigerant is expanded and/or metered into a storage device 24. Storage device 24 is realized as a pressure vessel 25 in which a phase boundary 26 forms between the liquid and the gaseous refrigerant. A flash-gas bypass 27 having a flash-gas valve 28 of cooling circuit 11 is connected to storage device 24 in such a manner that gaseous refrigerant can be taken out of storage device 24 and conducted to intermediate-pressure side 19 downstream of low-pressure compressor 13 and upstream of high-pressure compressor 14 in a flow direction of the refrigerant. Furthermore, a line section 29 is connected to storage device 24 in such a manner that liquid refrigerant can be taken out of storage device 24 and conducted to expansion valve 16.

Refrigerant flowing from gas cooler 15 to high-pressure valve 23 can be subcooled by internal heat exchanger 22, wherein the refrigerant flowing into intermediate-pressure side 19 upstream of high-pressure compressor 14 via flash-gas valve 28 can be overheated in internal heat exchanger 22. This ensures that gaseous refrigerant is located upstream of high-pressure compressor 14 such that high-pressure compressor 14 can aspirate only this refrigerant.

In addition, cooling circuit 11 comprises an intermediate-pressure bypass 30 having an intermediate-pressure valve 31, wherein intermediate-pressure bypass 30 is connected to line section 29 downstream of storage device 24 and to cooling circuit 11 and/or intermediate-pressure side 19 downstream of low-pressure compressor 13 and upstream of high-pressure compressor 14. Liquid refrigerant can be metered from storage device 24 into intermediate-pressure side 19 by intermediate-pressure valve 31, for example, if a temperature of the refrigerant is to be lowered upstream of high-pressure compressor 14. Furthermore, cooling circuit 11 comprises a low-pressure bypass 32 having a low-pressure valve 33, low-pressure bypass 32 being connected to line section 29 downstream of storage device 24 and to low-pressure side 18 directly upstream of low-pressure compressor 13 and downstream of valve device 17. Liquid refrigerant can be metered from storage device 24 into low-pressure side 18 upstream of low-pressure compressor 13 by low-pressure valve 33, for example, if refrigerant aspirated by low-pressure compressor 13 is to be cooled.

Cooling circuit 11 has another bypass 34 having another valve 35. Other bypass 34 is connected to line section 29 downstream of storage medium 24 and to low-pressure side 18 of cooling circuit 11 downstream of heat exchanger 12 and upstream of valve device 17. Liquid refrigerant can be metered from storage device 24 into low-pressure side 18 upstream of valve device 17 by other valve 35. This makes it possible to cool valve device 17, if necessary, and to provide a sufficient mass flow for low-pressure compressor 13 or high-pressure compressor 14.

Furthermore, cooling circuit 11 has a regulating bypass 36 having a regulating valve 37. Regulating bypass 36 is connected to intermediate-pressure side 19 downstream of low-pressure compressor 13 and upstream of high-pressure compressor 14 and to low-pressure side 18 of cooling circuit 11 upstream of low-pressure compressor 13 and downstream of valve device 17. Refrigerant can be metered from intermediate-pressure side 19 into low-pressure side 18 via regulating valve 37. This makes it possible to regulate a suction-gas temperature and/or a suction-gas pressure of the refrigerant on low-pressure side 18 upstream of low-pressure compressor 13 and to equalize, if required, a difference in pressure between intermediate-pressure side 19 and low-pressure side 18 of cooling circuit 11.

Valve device 17 is realized by a 3-way valve 38. Depending on the temperature requirement of a control device (not illustrated) of the test chamber, 3-way valve 38 is actuated by the control device in such a manner that refrigerant flowing from heat exchanger 12 is conducted directly to low-pressure compressor 13 via a low-pressure line 39 directly connected to 3-way valve 38. This refrigerant is compressed by low-pressure compressor 13 and then passes on to high-pressure compressor 14 for further compression. The control device can also actuate 3-way valve 38 in such a manner that the refrigerant reaches high-pressure compressor 14 by bypassing low-pressure compressor 13 via a compressor bypass 40 directly connected to 3-way valve 38. Compressor bypass 40 is connected to intermediate-pressure side 19 downstream of low-pressure compressor 13 and upstream of high-pressure compressor 14. Depending on a temperature requirement, it is thus possible to operate low-pressure compressor 13 together with high-pressure compressor 14 or just high-pressure compressor 14 alone. Since, in this case, low-pressure compressor 13 is switched off, significant energy saving can be achieved. High-pressure compressor 14 is operated alone in particular if, for example, a temperature of −20° C. is to be established in the test space. Low-pressure compressor 13 and high-pressure compressor 14 are operated together if, for example, a temperature of −50° C. is to be established in the test space.

Heat exchanger 12 is preferably realized with only one exchanger body (not illustrated in the case at hand), only one line of cooling circuit 11 running through the exchanger body. Thus, a surface area of the exchanger body can be fully used with cooling circuit 11, which is why a temperature difference between an atmosphere of the test space and heat exchanger 12 can be comparatively small if a temperature change is to be established in the test space. Furthermore, a heating device (not illustrated in the case at hand) having a heater and a heating heat exchanger is provided in the test space.

Furthermore, cooling device 10 has an oil device 41. Oil device 41 comprises an oil separator 42 and a feeding device 43. Feeding device 43 is realized by a feeding line 44 having a feeding valve 45 and metering valves 46 and 47. Moreover, oil separator 42 comprises a collector which is formed integrally with oil separator 42 (illustrated schematically in the case at hand) and is not shown in more detail. The oil in cooling circuit 11 serves to lubricate low-pressure compressor 13 and high-pressure compressor 14 during an operation. Oil separator 42 is disposed downstream of high-pressure compressor 14 in cooling circuit 11 and upstream of gas cooler 15 in the flow direction of the refrigerant and separates oil from the refrigerant and/or carbon dioxide flowing through oil separator 42. The oil in the collector is conducted into feeding line 44 via feeding valve 45 and from it to low-pressure compressor 13 and high-pressure compressor 14. Metering valve 46 and 47 are disposed in feeding line 44 directly upstream of low-pressure compressor 13 and high-pressure compressor 14, respectively, said metering valves 46, 47 introducing the oil in the desired quantity into respective compressors 13 and 14 for their lubrication. Here, the oil returns to cooling circuit 11 to oil separator 42. Thus, the oil circulates within a circuit 48 of oil device 41.

If compressors 13 and 14 are switched on, a temperature of the refrigerant close to an ambient temperature of, for example, 20° C. sets in during a longer standstill of compressors 13 and 14. Furthermore, a pressure equalization is accomplished within cooling circuit 11 via, for example, other bypass 34 and regulating bypass 36 such that a relatively even pressure P of the refrigerant prevails in cooling circuit 11. In this process, a partial quantity of the carbon dioxide is absorbed by the oil, in particular the oil in oil separator 42 and/or the collector, a quantity of carbon dioxide and/or its volume in cooling circuit 11 is reduced due to the absorption to such an extent that pressure P is smaller than or of the same size as a pressure Pₘₐₓ which is maximally allowable for cooling circuit 11. Therefore, it is not necessary to provide a standstill cooling or also a safety valve for delimiting the pressure to maximally allowable pressure Pₘₐₓ on cooling circuit 11.

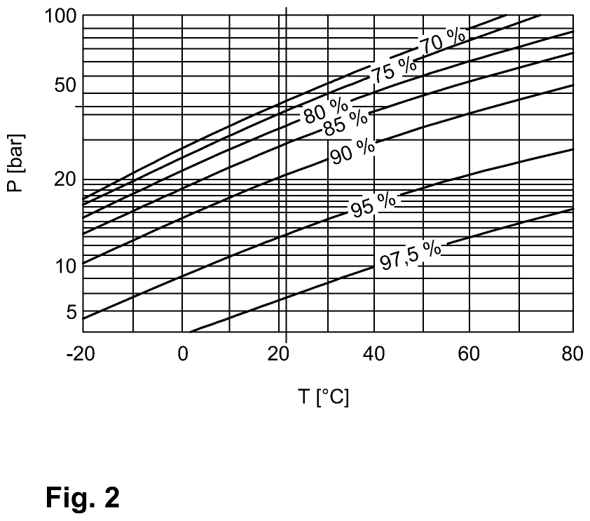

In the diagram in FIG. 2 showing a ratio of pressure P in bar and temperature T in ° C. of the refrigerant in cooling circuit 11, it can be seen that a percentage proportion of weight of the carbon dioxide of the total quantity of the carbon dioxide in cooling circuit 11 is absorbed by the oil. In the case at hand, this is illustrated by a characteristic curve field with parameters in percent by weight. For example, if cooling circuit 11 has a volume of about 70 liters of carbon dioxide and 7 liters of oil, a mass of 9.7 kg results for the carbon dioxide. A percentage proportion of weight of the carbon dioxide absorbed in the oil is 28 percent by weight or percent by mass at, for example, a temperature of 21.8° C. and a pressure of, for example, 43 bar. In this case, the oil absorbs a mass of the carbon dioxide of 1.9 kg. Thus, 7.8 kg of carbon dioxide remain in the cooling circuit. In contrast, ignoring the absorption of the carbon dioxide in the oil, a pressure would be about 40 bar.

1. A method for conditioning air in a test space of a test chamber, in particular a climate chamber, for receiving test material, the test space being sealable against an environment and being temperature-insulated, a temperature in a temperature range of −20° C. to +180° C. being established within the test space by cooling device of a temperature control device of the test chamber, which comprises a cooling circuit with carbon dioxide (CO₂) as a refrigerant, a heat exchanger in the test space, a compressor, an oil device, a gas cooler, and an expansion valve, the temperature in the test space being controlled and/or regulated by a control device of the test chamber, oil being separated from the refrigerant by at least one oil separator of the oil device and being conducted to the compressor by a feeding device of the oil device, a pressure P of the refrigerant being produced in the cooling circuit during a standstill of the compressor and at a temperature of the refrigerant corresponding to an ambient temperature, in particular of at least 20° C.,
wherein
a partial quantity of the carbon dioxide is absorbed by the oil, a quantity of carbon dioxide and/or a quantity of oil in the cooling circuit for producing pressure P being selected taking into account the absorption of the partial quantity of the carbon dioxide.

2. The method according to claim 1,
wherein
the partial quantity of the carbon dioxide is absorbed by the oil during a standstill of the compressor and at a temperature of the refrigerant of at least 20° C.

3. The method according to claim 1,
wherein
a ratio of the quantity of carbon dioxide and the quantity of oil in the cooling circuit is selected taking into account the absorption of the partial quantity of the carbon dioxide.

4. The method according to claim 1,
wherein
the quantity of oil in the cooling circuit is selected to be larger than a quantity of oil required for the operation of the compressor.

5. The method according to claim 1,
wherein
in the cooling circuit, pressure P of the refrigerant is smaller than or of the same size as a pressure Pₘₐₓ of the refrigerant, which is maximally allowable for the cooling circuit.

6. The method according to claim 1,
wherein
the refrigerant is neither cooled by a standstill cooling nor drained from the cooling circuit by means of a safety valve during the standstill of the compressor and at the temperature of the refrigerant of at least 20° C.

7. The method according to claim 1,
wherein
oil is stored by a collector of the oil device, the oil in the collector being conducted to the compressor via at least one feeding valve in a feeding line of the feeding device.

8. The method according to claim 7,
wherein
the feeding valve is opened when the compressor is operated and the feeding valve is closed when the compressor is stopped.

9. The method according to claim 7,
wherein
oil is metered into the compressor in the feeding line to the compressor by a metering valve of the feeding device.

10. The method according to claim 7,
wherein
a partial quantity of the oil in the collector is increased with a rising temperature of the refrigerant and reduced with a falling temperature of the refrigerant by the oil device.

11. The method according to claim 7,
wherein
a partial quantity of the oil in the collector is adjusted essentially linearly in relation to a temperature of the refrigerant by the oil device.

12. The method according to claim 7,
wherein
a filling volume of the collector is at least as large as a volume of oil in the cooling circuit.

13. The method according to claim 1, wherein
polyol ester oil is used as oil.

14. The method according to claim 1,
wherein
the cooling circuit is realized with a low-pressure compressor and a high-pressure compressor downstream of the low-pressure compressor in a flow direction of the refrigerant.

15. The method according to claim 1,
wherein pure carbon dioxide (CO₂) is used as the refrigerant.

16. The method according to claim 1,
wherein
the cooling circuit is operated in a thermodynamically transcritical state or in a subcritical state.

17. The method according to claim 1,
wherein
a temperature in a temperature range of −40° C. to +180°° C. is established within the test space by the temperature control device.

18. A test chamber, in particular a climate chamber, for conditioning air, the test chamber comprising a test space for receiving test material, the test space being sealable against an environment and being temperature-insulated, and a temperature control device for controlling the temperature of the test space, a temperature in a temperature range of −20° C. to +180° C. being establishable within the test space by means of the temperature control device, the temperature control device having a cooling device comprising a cooling circuit with carbon dioxide as a refrigerant, a heat exchanger in the test space, a compressor, an oil device, a gas cooler, and an expansion valve, the test chamber having a control device for controlling and/or regulating the temperature in the test space, oil being separable from the refrigerant by at least one oil separator of the oil device and being capable of being conducted to the compressor by a feeding device of the oil device, a pressure P of the refrigerant being producible in the cooling circuit during a standstill of the compressor and at a temperature of the refrigerant corresponding to an ambient temperature, in particular of at least 20° C., wherein a partial quantity of the carbon dioxide is absorbable by the oil, a quantity of carbon dioxide and/or a quantity of oil in the cooling circuit for producing pressure P being selected taking into account the absorption of the partial quantity of the carbon dioxide.

19. The test chamber according to claim 18,
wherein the oil device has a collector for storing oil, the collector being formed separately from or integrally with the oil separator.

20. The test chamber according to claim 18,
wherein the temperature control device comprises a heating device having a heater and a heating heat exchanger in the test space.
